(19) United States
(12) Patent Application Publication
(10) Pub. No.: US 2022/0245474 A1
(43) Pub. Date: Aug. 4, 2022

(54) Implementation of Rules in a Computing System

(71) Applicant: Pelion IoT Limited, Glasgow (GB)

(72) Inventors: Daniel Bell, Glasgow (GB); Ciaran Brendan McQuade, Glasgow (GB)

(73) Assignee: Pelion IoT Limited, Glasgow (GB)

(21) Appl. No.: 17/586,904

(22) Filed: Jan. 28, 2022

(30) Foreign Application Priority Data
Jan. 29, 2021 (GB) 2101261.2

(51) Int. Cl. G06N 5/02

(52) U.S. Cl. CPC G06N 5/025

(57) ABSTRACT

A rule to be implemented in a computing system is formulated as a set of at least three conditions in a hierarchical structure including a parent condition, two or more child conditions, and an outcome. One or more monitoring devices of at least some of the child conditions are instructed to report the status of the corresponding child condition. The status of the parent condition is then determined using the received status of the child conditions.

### BACKGROUND

The present disclosure relates to computer systems. More particularly, the present disclosure relates to decision engines implemented in computing systems to execute one or more rules.

Some computing applications utilise a decision engine to execute one or more rules against a source of data to determine whether or not the data complies with the rule(s). Based on the determination made by these rule(s), the decision engine may guide computer applications in various processes, for example under practical or business settings.

One applicable use of a decision engine in such settings is in the case of a Connectivity Management Platform (CMP). A CMP may provide connectivity management for mobile connectivity or cellular services, for example for Internet of Things (IoT) devices. In particular, a CMP may apply a number of rules to incoming data such as may be contained in subscriber identity module “SIM” action requests and network data packets. These request could be from various sources globally.

The source data of therefore tends to be geographically widespread for CMP platforms. Because of the widespread nature of the data sources, the present architecture of many of these platforms makes it problematic for localized processing. Similar problems exist in many other environments where the sources of data to be processed according to certain rules are geographically widespread.

### BRIEF DESCRIPTION OF THE DRAWINGS

Embodiments of the disclosure will be described, by way of example only and with reference to the following drawings, in which:

FIG. 1 illustrates a communication system in which some embodiments of methods described here may be implemented;

FIG. 2 is a flowchart showing a series of operations that may be performed in methods according to some embodiments;

FIG. 3 is an example of a truth table which may be implemented in some embodiments;

FIG. 4 illustrates another communication system in which some embodiments of methods described here may be implemented.

Common reference numerals are used throughout the figures to indicate similar features.

### DETAILED DESCRIPTION

As claimed in the Application Data Sheet, this application claims priority under 35 U.S.C. § 119(b) to foreign patent application number GB 21 01261.2, filed on Jan. 29, 2021, the content of which is incorporated herein by reference in its entirety.

Embodiments described below solve many of the problems described above. However the disclosure is not limited to solutions to these problems and some embodiments of the disclosure solve other problems.

The following summary is provided to introduce a selection of concepts in a simplified form that are further described below in the detailed description. This summary is not intended to identify key features or essential features of the claimed subject matter, nor is it intended to be used to determine the scope of the claimed subject matter.

According to some embodiments of the methods and systems described here, a rule may be formulated as at least three conditions in a hierarchical structure including a parent condition, two or more child conditions, and an outcome. For at least some of the child conditions, one or more monitoring devices of the conditions may be instructed to report the status of the corresponding condition, e.g. in a format such as fulfilled/not fulfilled, true/false or other binary format. The status of the parent condition may then be determined using the reported status of the child conditions.

By having the monitoring devices report the status of a condition, it is possible to reduce the amount of data transmitted from the monitoring devices for the implementation of the rule. For example, if the condition relates to temperature, a monitoring device may report only whether the temperature is above or below a threshold specified in the condition, rather than reporting temperature values at regular intervals for the status of the condition to be determined elsewhere.

More specifically, in one aspect there is provided in the following a method of implementing a rule in a computing system, the method comprising: formulating the rule as a set of at least three conditions in a hierarchical structure including a parent condition, two or more child conditions, and an outcome; instructing one or more monitoring devices of at least some of the child conditions to report the status of the corresponding child condition; receiving the status of the conditions from the one or more monitoring devices; and determining the status of the parent condition using the status of the child conditions received from the one or more monitoring devices.

In another aspect there is provided a computing system comprising one or more processors configured to implement the foregoing method.

In another aspect there is provided a computer readable medium comprising instructions comprising instructions which when implemented in a computing system cause the system to implement the foregoing method.

It will be appreciated that some embodiments of the disclosure enable a decision engine architecture to be geographically distributed, or decentralised. For example, the monitoring device(s) may be at a different geographical location from where the rule is implemented. This has a number of benefits to be described further here.

Features of different aspects and embodiments of the disclosure may be combined as appropriate, as would be apparent to a skilled person, and may be combined with any of the aspects of the disclosure.

Embodiments of methods and systems are described below by way of example only. These examples represent the best ways of putting the disclosure into practice that are currently known to the applicant although they are not the only ways in which this could be achieved.

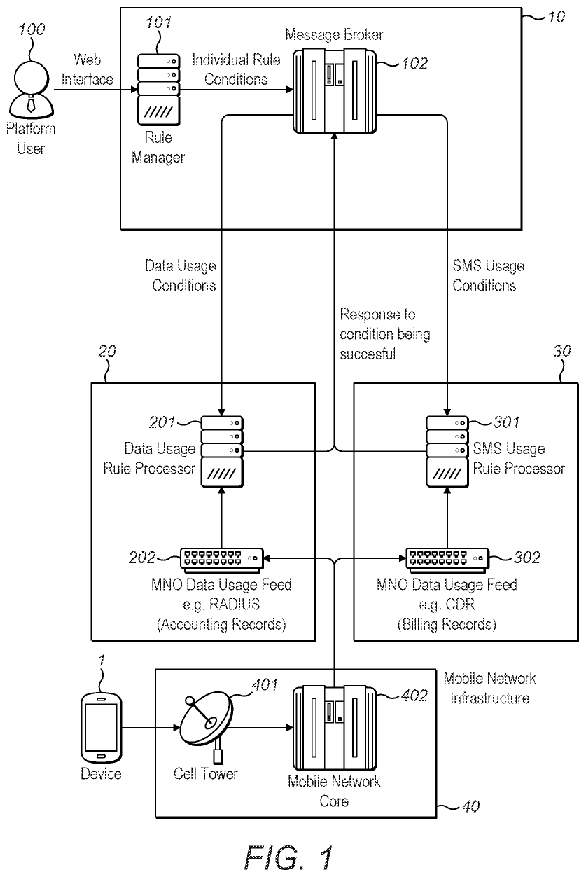

FIG. 1 illustrates a communication system in which some embodiments of methods described here may be implemented. The system of FIG. 1 is designed for management of data and short message service “SMS” usage by a mobile device 1. This is one example of many systems in which rules may be implemented and embodiments of the disclosure are not limited to connectivity management. In the system of FIG. 1, functions of connectivity management for the mobile device 1 are distributed across three sites, 10, 20, 30, which may be at different geographical locations, for example in different countries.

A computing system at site 10 is configured to implement a number of functions including a rule manager 101 and a message broker 102. The rule manager 101 may be accessed by a user 100 of mobile device 1 via a web interface. Rules for a particular user or device may be established using the rule manager 101 via the web interface, for example when the user activates a subscriber identity module “SIM” or changes a subscription plan. The rule manager 101 may output two or more conditions. A rule may be formulated based on the conditions, either at the rule manager or at the message broker 102.

The rule may specify two or more child conditions, a parent condition and an action or outcome. An example of a parent condition is “data usage>A (child condition 1) AND SMS usage>B (child condition 2)” and a possible outcome is “suspend all services to user”. It will be appreciated that more complex rules may be implemented in a system as described here and this simple rule is provided for the purpose of illustration only. In any of the embodiments described here, a parent condition may be a Boolean combination of the status of child conditions, but embodiments are not limited to this kind of parent/child relationship and others are possible.

The message broker 102 may implement the outcome, or instruct the outcome to be implemented, and may therefore be considered to operate as a decision engine. Therefore the message broker 102 needs to receive information relating to the conditions, i.e. in this example the data and SMS usage. These are reported to the message broker 102 from the other sites 20 and 30.

A computing system at site 20 is configured to implement a number of functions including a data usage rule processor 201 receiving data from a data usage feed 202. Thus one of the functions of the computing system at site 20 is to act as a monitoring device for a condition relating to data usage. The data usage feed 202 receives information from the mobile network core on data usage and feeds this into the data usage rule processor 201. The information could be provided from a Remote Authentication Dial-In User Service “Radius” server providing accounting information as is known in the field of mobile communications.

A computing system at site 30 is configured to implement a number of functions including a SMS usage rule processor 301 receiving data from a SMS usage feed 302, for example provided by a mobile network operator. Thus one of the functions of the computing system at site 30 is to act as a monitoring device for a condition relating to the SMS usage. The SMS usage feed 302 received information from the mobile network core on SMS usage and feeds this into the SMS usage rule processor 301. SMS usage information may be obtained from Call Detail Record “CDR” billing records provided by the mobile network operator.

Information is received at sites 20 and 30 from the mobile device 1 via a mobile network infrastructure 40 including for example a cell tower 401 and mobile network core 402, as is well known in this art. The outputs from sites 20 and 30 may be combined in a message bus, that is consumed by the message broker 102. For example, the communication paths shown in FIG. 1 from the individual sites 20 and 30 and the site 10 may be combined in a single message bus. The message bus may be a two directional message bus in which conditions are issued from the message broker in one direction and reports, e.g. “condition fulfilled” are reported back to the message broker in the other direction.

The message broker 102 may monitor the parent condition, e.g. “data usage>A (child condition 1) AND SMS usage>B (child condition 2)”=true/false, for example in a similar manner to the monitoring of data and SMS usage at the sites 20 and 30, by consuming the message bus for child condition status updates and continuously re-evaluating the status of the parent condition.

Some embodiments of the methods described here may be implemented in one or more state machines. State machines can be implemented in software, hardware or a hybrid of the two. Multiple state machines may communicate with each other. Therefore, some or all of the functions of the rule manager 101 and the monitoring devices may be implemented in one or more state machines. The status of a condition or the combined states of several conditions as described here may be represented as the state of a state machine.

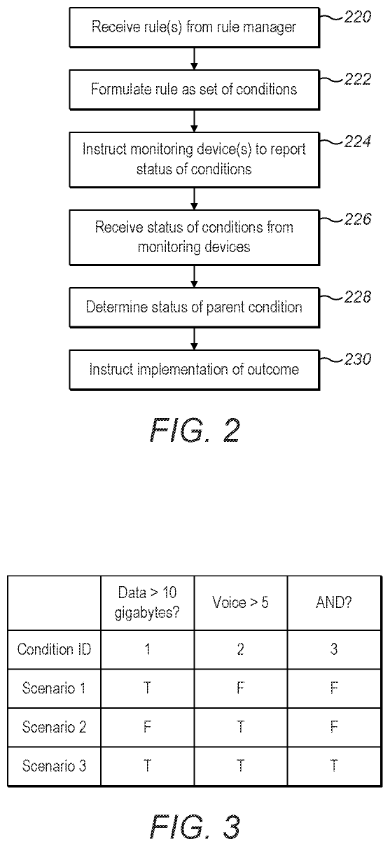

A series of operations that may be performed at the message broker will now be described with reference to FIG. 2. More generally these operations may be performed at any computing system performing any of the methods described here.

At operation 220, individual rules may be received from the rule manager 101. This operation is not essential in all embodiments, for example in methods or computing systems according to some embodiments the rules may have been predetermined, for example prior to commencing the method. An example of a rule may specify an operation on two or more conditions and an outcome.

At operation 222, the rule may be formulated as a set of at least three conditions in a hierarchical structure including a parent condition, two or more child conditions, and an outcome. For some of the child conditions at least, the conditions may be formulated as a question that requires a binary answer such as true or false or any other binary format, also known as a predicate. Two example conditions for the system of FIG. 1 are: “data usage>A?” and “SMS usage>B?”. Each condition, or predicate, may have a value of any type, for example numerical or Boolean. The return value is always Boolean, or binary. As will be described further, there is no limited to the nesting of conditions within a tree-like structure where child conditions can be parents of further conditions.

At operation 224, one or more monitoring devices for those child conditions, for which a condition was formulated in operation 222, is instructed to report the status of the corresponding child condition. In the example of FIG. 1, the message broker 102 may instruct the data usage rule processor 201 to report the status of the condition “data usage>A?” and the SMS usage rule processor 301 to report the status of the condition “SMS usage>B?”. In this example, one monitoring device monitors the status of each child condition. However it is possible for a monitoring device to monitor the status of more than one child condition.

At operation 226 the status of conditions is received from the monitoring devices, for example acting on instructions received in response to operation 224. In the example of FIG. 1 this may comprise receiving true or false indications from the data usage rule processor 201 and the SMS usage rule processor 301. The reporting from the monitoring devices may take place in any manner as is known in the art, for example but not limited to at regular intervals or in response to a status request from a message broker.

According to some embodiments, a monitoring device may be instructed to cease reporting the status of a condition once it has been fulfilled. According to some embodiments, a monitoring device may be instructed to report the status of a child condition only when it changes, or only when the condition has been fulfilled. Either of these options may further reduce the amount of messaging required from the monitoring device(s). Further, the instructions to monitoring devices at operation 224 may not be issued at the same time. A monitoring device for a child condition may be instructed to report the status of that condition only after another child condition in the same generation has been fulfilled. Where the parent condition has more than two children, each condition may be reported to it in succession, and optionally only when the condition has been fulfilled. The choice as to the timing of reporting from the monitoring devices may depend on the outcome. To take the example of if “data usage>A (child condition 1) AND SMS usage>B (child condition 2) then suspend all services to user”, there is no need for continued reporting.

At operation 228, the status of the parent condition of the child conditions, for which status was reported, is determined using the status of the conditions received from the one or more monitoring devices. Operation 228 may be the end of a method according to some embodiments.

At operation 230, according to some embodiments, an instruction is issued to implement the outcome, for example depending on the status of the parent condition. To take the example “data usage>A (child condition 1) AND SMS usage>B (child condition 2)”=true, the message broker may have the facility to suspend services to the user, or the message broker may issue an instruction to the mobile network infrastructure 40 to suspend services. In this example the conditions relate to parameters, data and SMS usage, that only increase and therefore once a threshold is breached the status will not reverse and therefore further reporting may not be required. Where the parameters may increase and decrease over time the timing of reporting may be different.

It will be appreciated that this example involving only parent and child conditions may be extended to any number of generations, or levels in the hierarchical structure. In the computing system of FIG. 1, the statuses of two child conditions are monitored at respective sites 20 and 30. Those child conditions may be parents of lower generation conditions. The status of the lower generation conditions may be monitored at sites 20 and 30 or at remote geographical locations reporting to sites 20 and 30. Operation 222 of FIG. 2 may involve formulating multiple generations of conditions as predicates.

The formulation of the conditions as predicates may be considered to be, and/or implemented as, a truth table, an example of which is shown in FIG. 3 for the rule: if data usage>10 gigabytes AND voice minutes>60 then→outcome. Here it can be seen that the outcome occurs only if the parent condition is true.

It can be seen from FIG. 3 that a rule may be broken down, according to embodiments of the methods and systems described here, into a truth-table-like structure in which each of the child conditions of the rule may be independently tested and for which a true/false result may be determined. Then, a further logic step is added in this example in which it is determined whether the binary result of the previous conditions (using Boolean, e.g. AND, OR or NOT logic) results in the conditions of the entire rule having been met for a particular input value. This further logic step may itself be considered to be a parent condition for which a true/false result may be determined.

In the particular example of FIG. 1, by providing this architecture, it is possible for localised processing of input data within the CMP which decentralises the rules engine and reduces the centralised processing burden. Breaking down the rules into separate logical predicates allows for a reduced load on rule checking in general, to evaluate the rule as a whole there is no need to check each predicate individually in series.

In some implementations, a message-based communication channel may be required to communicate messages between the individual services, using communication protocols such as the well-known Kafka, MQTT, and similar solutions. In the field of IoT the communication protocol may be LwM2M for example. A truth table may be stored in a stack style on this communication channel and can be evaluated by replaying the messages through the relevant services, for example at sites 20, 30 in the example of FIG. 1.

As noted above, a processor service, similar to the services that monitor data usage or SMS usage, may consume a message bus for condition value updates and continuously re-evaluate its logical operation conditions. For example this kind of processor service may be implemented at site 10, for example in the message broker, with the message broker continuously evaluating the status of the parent condition based on updates of the status of the child conditions. This arrangement is well suited to a decentralized methodology as it allows, for example, at least some child conditions such as Condition1 and Condition2 of the FIG. 3 truth table to be evaluated individually in geographically separate locations without any knowledge of the high level rule construct. Furthermore the logical operator processes benefit from the same load spreading and resiliency improvements, since many of them may be run on the same message bus.

The “table” may be stored as a flat set of messages on the message bus. The latest message on the bus may represent the current Boolean value of the condition.

According to some embodiments, each condition or its corresponding predicate may be assigned an identity. Where two or more rules are being implemented, the same condition may appear in more than one rule and have the same identity. In other words the identity may be independent of the rule in which the condition is comprised. In order to achieve this a consistent method of formulating the conditions and assigning the identities is required. One suitable method of assigning the identities is to use a hash function. In other words the identity of a condition may be a hash of the condition.

The messages on the communication bus from the monitoring devices may be read in a FIFO (First-In First-Out) order in order to determine current state. An example of rule hashing will now be described:

Rule: “FOR subscriberX IF data_usage>10 AND sms_usage>100 THEN outcome” may be formulated as predicates:
Rule1Condition1id: data_usage>10 FOR SubscriberX
Rule1Condition2id: sms_usage>100 FOR SubscriberX
Rule1Condition3id: Rule1Condition1 AND Rule1Condition2

A hashing scheme may be:
Rule1Condition1id: HASH (data_usage>10+SubscriberX)
Rule1Condition2id: HASH (sms_usage>100+SubscriberX)
Rule1Condition3id: HASH (Rule1Condition1id+Rule1Condition2id)

The rules may be stored by their ID, e.g. their hash, and this enables automatic deduplication of rules globally. For example:
Rule 1: FOR subscriberX IF data_usage>10 AND sms_usage>100 THEN send email
Rule 2: FOR subscriberX IF data_usage>10 THEN send_sms

Here two rules share the same condition and in this example the same subscriber they're executing the “data_usage>10” for, the condition will be shared between the two rules, lowering the overall system load per rule.

Alternatively, where a method as described here is implemented in one or more state machines, the identity of a condition or its corresponding predicate may be the state of a state machine.

Embodiments of methods described here are not limited to one parent and two child conditions, and may include any number of generations in which one or more children are also parents. Further, the number of child conditions in any generation is not limited.

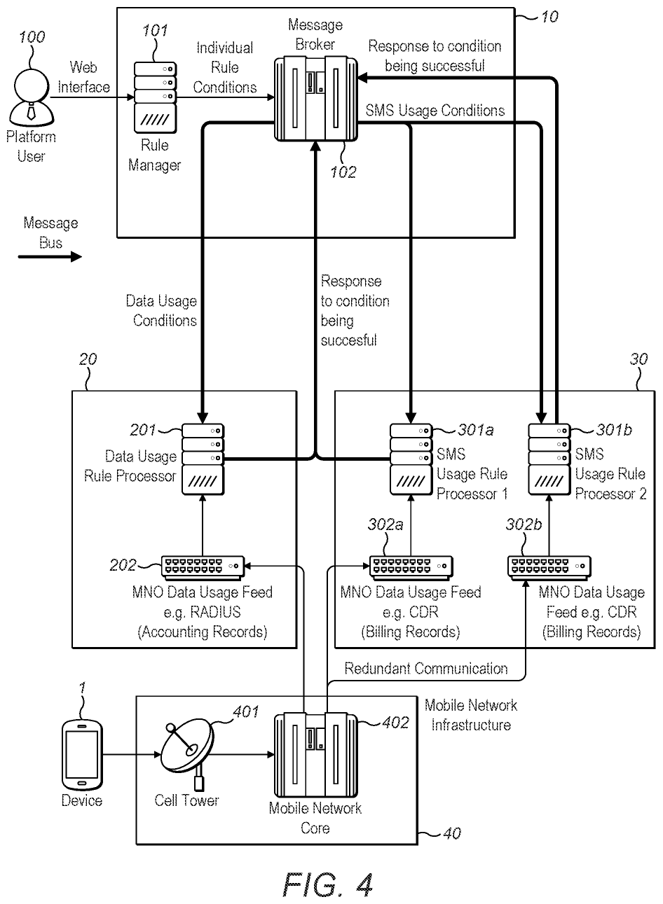

One alternative example including additional child conditions is shown in FIG. 4. FIG. 4 is similar to FIG. 1 except that two conditions are monitored at site 30. Embodiments are not limited to the number of sites, optionally geographically separated, in a communication system. Further, the number of conditions being monitored at any site is not limited. The example of FIG. 4 shows two conditions being monitored at 30, by respective SMS usage rule processors 301a, 301b being supplied by respective SMS usage feeds 302a, 302b. The SMS usage may correspond to different users or different kinds of SMS activity by the same user 100.

As noted in the foregoing, a decentralized model between a core of an automation engine and individual processors allows for computation closer to where the condition being monitored is happening. To take the example of a CMP, the computation may take place closer to the mobile network integration points, for example at the edge devices of a CMP.

There are many benefits of this architecture over a purely centralized one, including but not limited to:
Less data transfer between sites
Beneficial to countries that have stricter data sovereignty laws—for example the privacy of the data to which the condition relates may be maintained if only the status of the condition is reported
Less load on the interconnects between sites
Quicker to catch up if there's a network link failure between sites, for example since less data has to be transferred
Rules can be distributed across multiple instances of the same interconnect to allow for resiliency and load spreading.

It will be appreciated from the foregoing that the functions of any of the computing systems described herein may be distributed across multiple computing systems, for example for improved decentralisation. Further, some of the computing systems may be combined in a single computing system with multiple functions, for example to monitor the conditions of multiple child conditions, optionally in multiple generations.

Some operations of the methods described herein may be performed by software in machine readable form e.g. in the form of a computer program comprising computer program code. Thus some aspects of the disclosure provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method steps may be carried out in any suitable order, or simultaneously. Other embodiments may be implemented in hardware or a combination of software and hardware.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described above are largely automated. In some examples a user or operator of the system may manually instruct some steps of the method to be carried out.

In the described embodiments of the disclosure the system may be implemented as any form of a computing and/or electronic system as noted elsewhere herein. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method steps or elements identified, but that such steps or elements do not comprise an exclusive list and a method or apparatus may contain additional steps or elements.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A method of implementing a rule in a computing system, the method comprising:
formulating the rule as a set of at least three conditions in a hierarchical structure including a parent condition, two or more child conditions, and an outcome;
instructing one or more monitoring devices of at least some of the child conditions to report a status of a corresponding child condition;
receiving the status of the conditions from the one or more monitoring devices; and
determining a status of the parent condition using the status of the child conditions received from the one or more monitoring devices.

2. The method of claim 1, where the parent condition is a logical operation on two or more child conditions.

3. The method of claim 2, where the logical operation is a Boolean operation.

4. The method of claim 1, further comprising assigning an identity to the conditions for which the one or more monitoring devices are instructed to report the status.

5. The method of claim 4, where said receiving the status of the conditions is reported in a message including the condition identity and a condition status.

6. The method of claim 4, where the method implements two or more rules, and where a condition included in more than one rule is assigned a same identity.

7. The method of claim 6, where the identity is a hash of the corresponding condition, or where the method is implemented in one or more state machines and the identity is a state of a state machine.

8. The method of claim 5, where the method implements two or more rules, and where a condition included in more than one rule is assigned a same identity.

9. The method of claim 8, where the identity is a hash of the corresponding condition, or where the method is implemented in one or more state machines and the identity is a state of a state machine.

10. The method of claim 1, further comprising instructing a monitoring device to report the status of a child condition only when the status of the child condition changes.

11. The method of claim 1, further comprising instructing a monitoring device of a child condition to report the status of that condition only after another child condition in a same generation has been fulfilled.

12. The method of claim 1, further comprising instructing a monitoring device to end reporting of the status of a condition in response to the condition being fulfilled.

13. The method of claim 1, where one or more of the child conditions are parents of lower generation conditions.

14. The method of claim 1, further comprising receiving the status of the conditions as a set of messages on a message bus.

15. The method of claim 14, where a latest message on the message bus represents a current value of the condition.

16. The method of claim 1, where the method is implemented in a connectivity management platform for mobile connectivity, and where the conditions relate to consumption of connectivity services by a subscriber device.

17. The method of claim 1, where the method is implemented in a computing system in which the monitoring devices are at remote geographical locations from the computing system.

18. A non-transitory computer-readable medium storing instructions that, when executed by a processor, cause the processor to implement the method of claim 1.

19. A computing system comprising one or more processors configured to implement the method of claim 1.
